(19) United States
(12) Patent Application Publication
(10) Pub. No.: US 2013/0083748 A1
(43) Pub. Date: Apr. 4, 2013

(54) METHOD AND APPARATUS FOR PROCESSING CSI (CHANNEL STATE INFORMATION) IN A WIRELESS COMMUNICATION SYSTEM

(71) Applicant: INNOVATIVE SONIC CORPORATION, Taipei City (TW)

(72) Inventor: Ming-Che Li, Taipei City (TW)

(73) Assignee: INNOVATIVE SONIC CORPORATION, Taipei City (TW)

(21) Appl. No.: 13/627,187

(22) Filed: Sep. 26, 2012

Related U.S. Application Data
(60) Provisional application No. 61/539,202, filed on Sep. 26, 2011.

(51) Int. Cl. H04W 72/04

(52) U.S. Cl. CPC H04W 72/042
USPC 370/329

(57) ABSTRACT

A method and apparatus are disclosed for processing CSI (Channel State. Information) in a wireless communication system, The method includes configuring a User Equipment (UE), in a subframe, to transmit periodic CSI reporting and HARQ-ACK (Hybrid Automatic Repeat and request-Acknowledgement), wherein there is no PUSCH (Physical Uplink Shared Channel) transmission in the subframe. The method further includes indicating in the PDCCH (Physical Downlink Control Channel) scheduling the PDSCH (Physical Downlink Shared Channel) transmission to which the HARQ-ACK corresponds, wherein whether the periodic CSI reporting and the HARQ-ACK are multiplexed on PUCCH (Physical Uplink Control Channel) or not would depend on the indication in the PDCCH.

### CROSS-REFERENCE TO RELATED APPLICATIONS

The present Application claims the benefit of U.S. Provisional Patent Application Ser. No. 61/539,202 filed on Sep. 26, 2011, the entire disclosure of which is incorporated herein by reference.

### FIELD

This disclosure generally relates to wireless communication networks, and more particularly, to a method and apparatus for processing CSI (Channel State Information) in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly; changes to the current body of 3GPP standard are currently being submitted and considered to evolve and finalize the 3GPP standard.

### SUMMARY

A method and apparatus are disclosed for processing CSI (Channel State Information) in a wireless communication system. The method includes configuring a User Equipment (UE), in a subframe, to transmit periodic CSI reporting and HARQ-ACK (Hybrid Automatic Repeat and request-Acknowledgement), wherein there is no PUSCH (Physical Uplink Shared Channel) transmission in the subframe. The method further includes indicating in the PDCCH (Physical Downlink Control Channel) scheduling the PDSCH (Physical Downlink Shared Channel) transmission to which the HARQ-ACK corresponds, wherein whether the periodic CSI reporting and the HARQ-ACK are multiplexed on PUCCH (Physical Uplink Control Channel) or not would depend on the indication in the PDCCH.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a flow chart according to one exemplary embodiment,

### DETAILED DESCRIPTION

The exemplary wireless communication systems and devices described below employ a wireless communication system, supporting a broadcast service. Wireless cot systems are widely deployed to provide various types of communication such as voice, data, and so on. These systems may be based on code. division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. 3GPP TS 36,213 V10.2.0, “E-UTRA Physical layer procedures (Release 10)”; R1-112034, “Uplink signaling enhancements in Rel-11 carrier aggregation”, Huawei, HiSilicon; and R1-112497, “HARQ-ACK and CSI Multiplexing in PUCCH for DL CA”, Samsung; R1-112104, “Enhancement for CSI transmission in LTE-A Rel-11 with CA”, CATT; and R1-112496, “Multi-Cell Periodic CSI Reporting”, Samsung. The standards and documents listed above are hereby expressly incorporated herein.

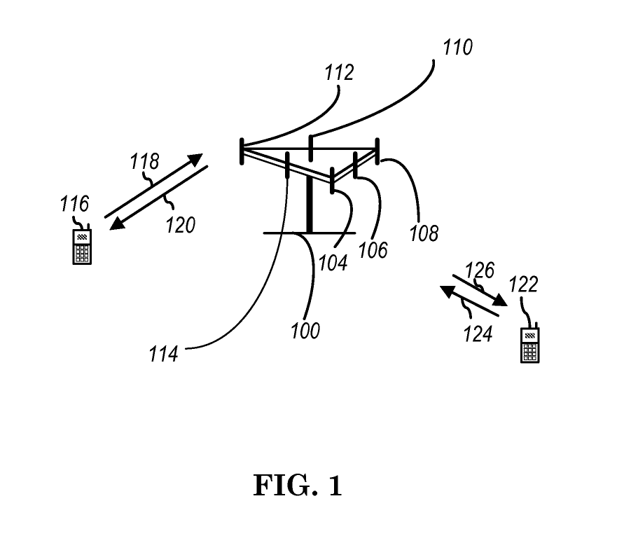

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group, Access terminal 116 (AT) is in communication with antennas 112 and 114, where antennas 112 and 114 transmit information to access terminal 116 over forward link 120 and receive information, from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse Link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (LIE), a wireless communication device, terminal, access terminal or some other terminology.

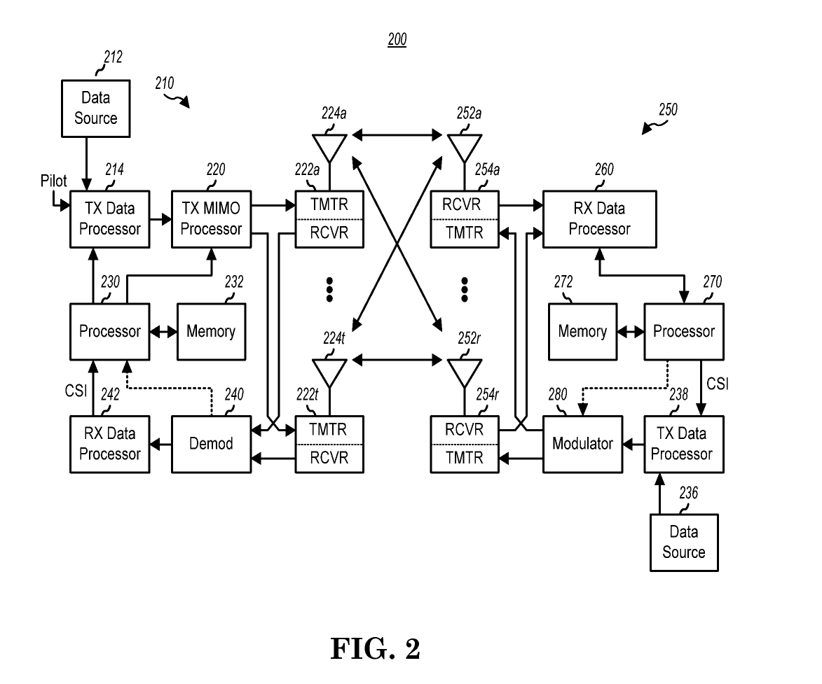

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream, to provide, coded data.

The coded data for each data stream may be multiplexed with pilot, data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined, by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data. stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system. 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

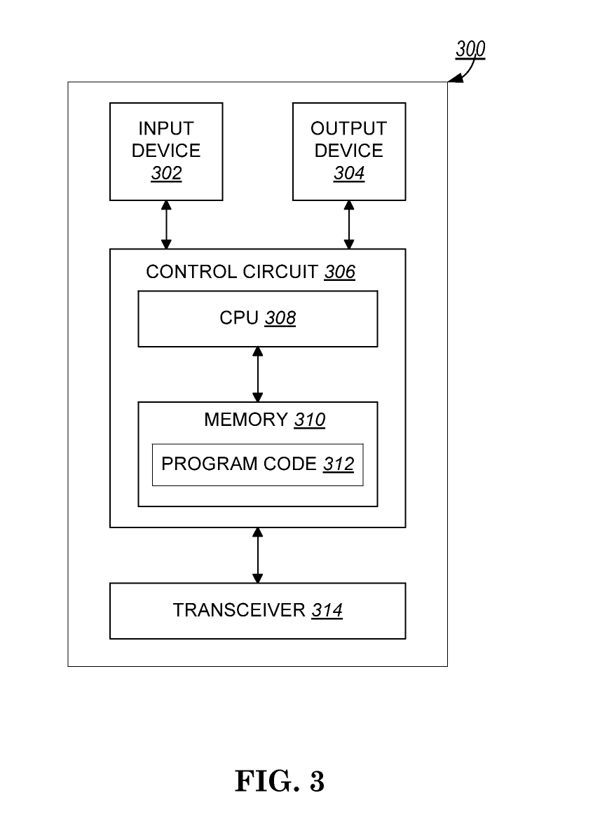

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

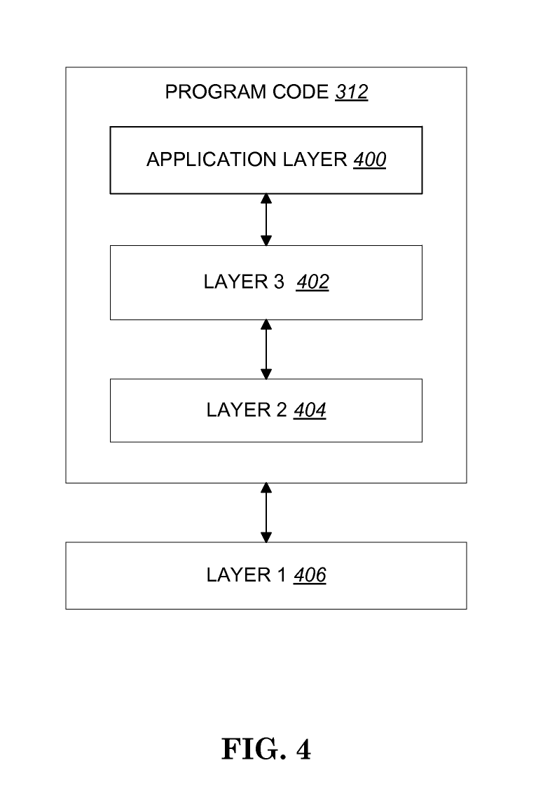

FIG. 4 is a simplified block diagram of the program. code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In LTE Rel.10 carrier aggregation, PUCCH format 2 is used for periodic CSI reporting on PUCCH. For a given subframe, if the periodic CSI report of one serving cell collides with the. periodic CSI report of another serving cell, the periodic CSI report with lower priority would be dropped. As discussed in 3GPP TS 36.213 V10.2.0, the TDM mechanism is generally used to avoid collision of the periodic CSI reporting of different serving cells. However, as the number of activated serving cells is more than 2, TDM mechanism would not be so efficient. Firstly, it would result in a longer CSI reporting periodicity for some serving cells, and thus, eNB is unable to efficiently schedule the corresponding serving cells, especially for TDD, Secondly, TDM could avoid the collision among periodic CSI of multiple serving cells, but it wilt increase reporting instances of periodic CSI, and thus increase the collision probability of CSI and HARQ-ACK, which will still result in dropping periodic CSI frequently, as discussed in 3GPP R1-112034.

As discussed in 3GPP R1-112104 and R1-112496, “Multi-Cell Periodic CSI Reporting”, Samsung, for CA enhancement in Rel.11, it has been suggested to consider periodic CSI reporting of multiple serving cells on PUCCH, such as using PUCCH format 3 and/or modified. PUCCH format 3.

In general, with support of (modified) PUCCH format 3, UE could transmit periodic CSI reporting of multiple serving cells simultaneously. Since the reporting occasions are synchronized on both network and UE sides, UE could be configured with one PUCCH format 2 resource and one (modified) PUCCH format 3 resource, and could transmit periodic. CSI reporting on one of the resources depending on the number of reported serving cells.

In Rel.10, if :uplink HARQ-ACK has more than two bits, multiplexing HARQ-ACK and periodic CSI reporting on PUCCH would not be supported due to lack of time for discussion. In this case, periodic CSI reporting would be dropped if there is no PUSCH transmission. Thus, how to multiplex HARQ-ACK and periodic. CSI reporting on PUCCH would need to be considered to avoid frequently periodic CSI dropping.

In general, it is natural that when HARQ-ACK transmission on PUCCH format 3 is multiplexed with one periodic CSI reporting of one serving sell on PUCCH format 2, the CSI reporting could be transmitted on the PUCCH format 3 for HARQ-ACK transmission. When HARQ-ACK transmission on PUCCH format 3 is multiplexed with periodic CSI reporting of multiple serving cells on (Modified) PUCCH format 3, the HARQ-ACK could be transmitted on the (Modified) PUCCH format 3 for CSI reporting.

In the current specification, the maximum payload of periodic CSI reporting is 11 bits, and the number of maximum deliverable HARQ-ACK bits on PUCCH format 3 is 20 bits, especially in TDD. When HARQ-ACK is multiplexed with periodic CSI reporting, HARQ-ACK would occupy the quota of periodic CSI reporting of one or two serving cells, When HARQ-ACK bits are more than 10 bits, bundling may be required if dropping periodic CSI reporting of only one serving cell is allowed. Also, as discussed in 3GPP R1-112497, multiplexing HARQ-ACK and periodic CSI reporting may have some impact on HARQ-ACK reliability due to increase of code rate, power issue.

There may be a trade-off between HARQ-ACK reliability reduction and periodic. CSI dropping. In view of the trade-off, it may be beneficial to have more flexibility in network, unlike whether multiplexing HARQ-ACK and CSI or not depends on higher layer configuration.

In general, the network should have more flexibility to determine whether multiplexing HARQ-ACK and periodic CSI reporting or not, such as indicated from PDCCH. When periodic CSI reporting collides with the HARQ-ACK transmission with more than 2 bits in a subframe, it is proposed that within the four codepoints to indicate PUCCH resource for HARQ-ACK feedback in PDCCH. Some codepoint(s) indicate HARQ-ACK and periodic. CSI reporting multiplexing on PUCCH is enabled, while other codepoint(s) indicate HARQ-ACK would be transmitted with CSI dropping. For example, PUCCH format 3 is configured for HARQ-ACK transmission and when a specific codepoint is indicated, the CSI reporting could be transmitted on the indicated PUCCH resource 3 with HARQ-ACK multiplexing. As another example, if the periodic CSI reporting of multiple serving cells on PUCCH is supported, a specific codepoint could indicate the PUCCH resource for periodic CSI reporting of multiple serving cells, and then HARQ-ACK would be transmitted on this indicated PUCCH resource with CSI multiplexing, This indication may be valid only for the collision subframe,

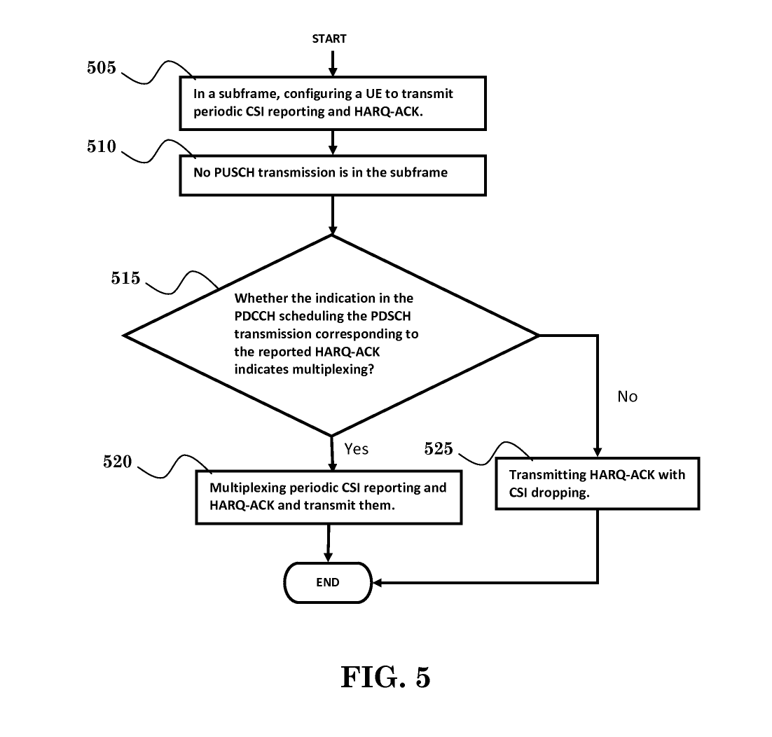

FIG. 5 illustrates an exemplary flowchart 500 in accordance with one embodiment. As shown in step 505 of FIG. 5, the UE is configured, through a subframe, to transmit periodic CSI reporting and HARQ-ACK (Hybrid Automatic Repeat and Request-Acknowledgement). As shown in step 510, there is no PUSCH (Physical Uplink Shared Channel) transmission in the subframe. Step 515 Checks the indication in the PDCCH (Physical Downlink Control Channel) scheduling, the PDSCH (Physical Downlink Shared Channel) transmission to which the reported HARQ-ACK corresponds. If the indication specifies multiplexing, the periodic CSI reporting and the HARQ-ACK should be multiplexed and transmitted, as shown in step 520. However, if the indication does not specify multiplexing, the HARQ-ACK should be transmitted with the CSI dropping, as shown in step 525.

In one embodiment, the PDSCH transmission occurs on a secondary cell. Also, PUCCH format 3 could be configured and used for HARQ-ACK transmission. Alternatively, PUCCH format 1b with channel, selection could he configured and used for HARQ-ACK transmission. Furthermore, PUCCH format 3 or modified PUCCH format 3 could be used for periodic CSI reporting of multiple serving cells.

In one embodiment in which the indication in the PDCCH is the field used to determine the PUCCH resource for HARQ-ACK feedback, sonic codepoint(s) would be used to indicate the HARQ-ACK and periodic CSI report multiplexing, and some other codepoint(s) would be used to indicate- HARQ-ACK with CSI dropping, In this embodiment, when a specific codepoint is selected, the periodic CSI reporting and the HARQ-ACK would be transmitted on the PUCCH resource corresponding to the selected codepoint. In addition, the PUCCH resource corresponding to the selected codepoint could be a PUCCH format 3 resource and/or a resource originally for transmission of the periodic CSI reporting to multiple serving cells. Furthermore, for a subframe with periodic. CSI reporting and HARQ-ACK collision, the selected codepoint would correspond to a resource originally for transmission of the periodic CSI reporting of multiple serving cells. For a subframe without periodic CSI reporting and HARQ-ACK the selected codepoint would correspond to a PUCCH resource for HARQ-ACK transmission.

Referring back to FIGS. 3 and 4, the UE 300 includes a program code 312 stored in memory 310. In one embodiment, the CPU 308 could execute the program code 312 (i) to configure a User Equipment (UP), in a subframe, to transmit periodic CSI reporting and HARQ-ACK (Hybrid Automatic Repeat and request-Acknowledgement), wherein there is no PUSCH (Physical Uplink Shared Channel) transmission in the subframe, and (ii) to indicate in the PDCCH (Physical Downlink: Control Channel) scheduling the PDSCH (Physical Downlink Shared Channel) transmission to which the HARQ-ACK corresponds, wherein whether the periodic CSI reporting and the HARQ-ACK are multiplexed on PUCCH (Physical Uplink Control Channel) or not would depend on the indication in the PDCCH.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while, remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure, In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for processing CSI (Channel State Information) in a wireless communication system, comprising:
configuring a User Equipment (UE), in a subframe, to transmit periodic CSI reporting and HARQ-ACK (Hybrid Automatic Repeat and request-Acknowledgement), wherein there is no PUSCH (Physical Uplink Shared Channel) transmission in the subframe; and
indicating in the PDCCH (Physical Downlink Control Channel) scheduling the PDSCH (Physical Downlink Shared Channel) transmission to which the HARQ-ACK corresponds, wherein whether the periodic CSI reporting and the HARQ-ACK are multiplexed on PUCCH (Physical Uplink Control Channel) or not would depend on the indication in the PDCCH.

2. The method of claim 1, wherein the PDSCH transmission is on a secondary cell.

3. The method of claim 1, configuring and using PUCCH format 3 is configured for HARQ-ACK transmission.

4. The method of claim 1, configuring and using PUCCH format 1b with channel selection is configured for HARQ-ACK transmission.

5. The method of claim 1, configuring and using PUCCH format 3 or modified PUCCH format 3 for periodic CSI reporting of multiple serving cells.

6. The method of claim 1, wherein the indication in the PDCCH is the field used to determine the PUCCH resource for HARQ-ACK feedback, a first set of codepoint(s) would indicate the HARQ-ACK and periodic CSI reporting multiplexing, and a second set of codepoint(s) would indicate HARQ-ACK transmission with CSI dropping.

7. The method of claim 6, wherein if a codepoint in the first set of codepoint(s) is selected, periodic CSI reporting and HARQ-ACK would be transmitted on the PUCCH resource corresponding to the selected codepoint.

8. The method of claim 7, wherein the PUCCH resource corresponding to the selected codepoint is a PUCCH format 3 resource.

9. The method of claim 7, wherein the PUCCH resource corresponding to the selected codepoint is a resource originally for transmission of the periodic CSI reporting of multiple serving cells.

10. The method of claim 9, wherein for a subframe with periodic CSI reporting and HARQ-ACK collision, the selected codepoint would correspond to a resource originally for transmission of the periodic CSI reporting of multiple serving cells; and for a subframe without periodic CSI reporting and HARQ-ACK collision, the selected codepoint would correspond to a PUCCH resource for HARQ-ACK transmission.

11. A communication device for processing CSI (Channel State Information) in a wireless communication system, the communication device comprising:
a control circuit;
a processor installed in the control circuit;
a memory installed in the control circuit and operatively coupled to the processor;
wherein the processor is configured to execute a program code stored in memory to process the CSI by:
configuring a User Equipment (UE), in a subframe, to transmit periodic CSI reporting and HARQ-ACK (Hybrid Automatic Repeat and request-Acknowledgement), wherein there is no PUSCH (Physical Uplink Shared Channel) transmission in the subframe; and
indicating lathe PDCCH (Physical Downlink Control Channel) scheduling the PDSCH (Physical Downlink Shared Channel) transmission to which the HARQ-ACK corresponds, wherein whether the periodic CST reporting and the HARQ-ACK are multiplexed on PUCCH (Physical Uplink Control Channel) or not would depend on the indication in the PDCCH.

12. The communication device of claim 11, wherein the PDSCH transmission is on a secondary cell.

13. The communication device of claim 11, configuring and using PUCCH format 3 is configured for HARQ-ACK transmission.

14. The communication device of claim 11, configuring and using PUCCH format 1b with channel selection is configured for HARQ-ACK transmission.

15. The communication device, of claim 11, configuring and using PUCCH format 3 or modified PUCCH format 3 for periodic CSI reporting of multiple serving cells.

16. The communication device of claim 11, wherein the indication in the PDCCH is the field used to determine the PUCCH resource for HARQ-ACK feedback, a first set of codepoint(s) would indicate the HARQ-ACK and periodic CSI reporting multiplexing, and a second set of codepoint(s) would indicate HARQ-ACK transmission with CSI dropping.

17. The communication device of claim 16, wherein if a codepoint in the first set of codepoint(s) is selected, periodic CSI reporting and HARQ-ACK would be transmitted on the PUCCH resource corresponding to the selected codepoint.

18. The communication device of claim 17, wherein the PUCCH resource corresponding to the selected codepoint is a PUCCH format 3 resource.

19. The communication device of claim 17, wherein the PUCCH resource corresponding to the selected codepoint is a resource originally for transmission of the periodic CSI reporting of multiple serving cells.

20. The communication device of claim 19, wherein for a subframe with periodic CSI reporting and HARQ-ACK collision, the selected codepoint would correspond to a resource originally for transmission of the periodic CSI reporting of multiple serving cells; and far a subframe without periodic CSI reporting and HARQ-ACK collision, the selected codepoint would correspond to a PUCCH resource for HARQ-ACK transmission.
